(19) United States
(12) Patent Application Publication
(10) Pub. No.: US 2014/0129377 A1
(43) Pub. Date: May 8, 2014

(54) ELECTRONIC INVOICE GATEWAY

(71) Applicant: NEXIN, LONG BEACH, CA (US)

(72) Inventor: Joel NAKABAYASHI, Long Beach, CA (US)

(73) Assignee: NEXIN, LONG BEACH, CA (US)

(21) Appl. No.: 13/670,268

(22) Filed: Nov. 6, 2012

(51) Int. Cl. G06Q 40/00; G06Q 30/06

(52) U.S. Cl. 705/26.8; 705/34

(57) ABSTRACT

Methods for processing electronic purchase orders and invoices from a single customer and a plurality of vendors may comprise receiving electronic purchase orders from a customer for a plurality of vendors; directing each of said electronic purchase order to a vendor account associated with each vendor; receiving an electronic invoice corresponding to each of said electronic purchase orders; and directing the electronic invoices to the customer account associated with the customer. Computer implemented methods may also allow vendors and customers to simultaneously access all outstanding purchase orders and invoices.

### FIELD OF THE APPLICATION

The present application relates to methods for improved transmittal of purchase orders and invoices between customers and vendors.

### DESCRIPTION OF THE RELATED ART

Many vendors, irrespective of the goods or services provided, offer their customers electronic access to historical and current invoices. However, the invoices are often available only through the vendor's proprietary software.

Likewise, many vendors, irrespective of the goods or services provided, accept electronic purchase orders from their customers, which again are often only able to be submitted through the vendor's proprietary software.

Because of this, customers who place purchase orders and track invoices with a number of different vendors, e.g., business customers, are faced with labor intensive and potentially error inducing manual data entry when they compile invoices and/or purchase orders with different vendors.

One attempt to reduce the cost and potential errors associated with manual data entry has been to transfer or send electronic invoices and/or purchase orders as files between the vendor and customer. However, due to the variety of file formats available, there can be compatibility and file conversion issues for a customer with multiple vendors. A simplified system allowing electronic communication of the content of invoices and purchase orders between vendors and their customers without a customer having to transfer, convert, and compile numerous discrete files is desired.

### BRIEF SUMMARY OF THE INVENTION

Embodiments of the application provide an electronic purchase order and/or invoice gateway. These embodiments provide a general technique for managing electronic communication between customers and vendors, and compiling outstanding purchase orders and/or invoices for simultaneous viewing by a customer or vendor. Such a technique may be used to reduce the time, cost, and potential errors associated with manual communication and purchase order and invoice tracking.

One embodiment comprises a non-transitory computer readable medium having computer executable program code embodied thereon, the computer executable program code configured to cause a computing device to provide a customer with simultaneous access to electronic invoices from one or more vendors by: receiving electronic invoices from one or more vendors for transactions with a customer; and directing said electronic invoices from the one or more vendors to a customer account associated with the customer. In this embodiment, the customer can simultaneously access the electronic invoices from the one or more vendors by accessing their customer account. In some embodiments, simultaneously accessing the electronic invoices from the one or more vendors comprises accessing a single report comprising electronic invoice data from the one or more vendors.

In some embodiments, the computer executable program code is further configured to cause a computing device to send an electronic notification to the customer when an electronic invoice is directed to the associated customer account.

In some embodiments, the computer executable program code is further configured to receive electronic invoices from the one or more vendors via the internet.

In some embodiments, the computer executable program code is further configured such that a customer accesses their account via the internet, such as with a web-enabled mobile device.

In some embodiments, the one or more vendors is two or more vendors.

Another embodiment comprises a non-transitory computer readable medium having computer executable program code embodied thereon, the computer executable program code configured to provide an electronic customer purchase order and vendor invoice gateway by: receiving an electronic purchase order from a customer for a transaction with a vendor; directing said electronic purchase order to a vendor account associated with the vendor; receiving an electronic invoice from the vendor upon acceptance of the electronic purchase order; and directing the electronic invoice to a customer account associated with the customer.

In some embodiments, the computer executable program code is configured to receive a plurality of electronic purchase orders from a customer for transactions with a plurality of vendors.

In some embodiments, the computer executable program code is further configured to cause a computing device to send an electronic notification to a vendor when an electronic purchase order is directed to the associated vendor account. In some embodiments, the computer executable program code is further configured to cause a computing device to send an electronic notification to the customer when an electronic invoice is directed to the associated customer account.

In some embodiments, an electronic purchase order is received from the customer via the internet, such as from a web-enabled mobile device.

In some embodiments, an electronic invoice is received from the vendor via the internet.

In some embodiments, the computer executable program code is further configured such that a customer accessing their account may access historical account information, such as electronic purchase orders previously sent to one or more vendors, or electronic invoices previously sent by one or more vendors.

In some embodiments, the computer executable program code is further configured such that a customer accessing their account may simultaneously access outstanding electronic invoices sent by a plurality of vendors.

In some embodiments, the computer executable program code is further configured such that a vendor accessing their account may access historical account information, such as electronic purchase orders previously sent by one or more customers, or electronic invoices previously sent to one or more customers.

In some embodiments, the computer executable program code is further configured such that a vendor accessing their account may simultaneously access all outstanding invoices sent to a single customer.

In some embodiments, the computer executable program code is further configured such that a vendor accessing their account may simultaneously access all outstanding invoices.

In other embodiments, methods of processing electronic purchase orders and invoices from a single customer and a plurality of vendors are presented. The methods comprise: receiving electronic purchase orders from a customer for a plurality of vendors; directing each of said electronic purchase order to a vendor account associated with each vendor; receiving an electronic invoice corresponding to each of said electronic purchase orders; and directing the electronic invoices to a customer account associated with the customer.

In some embodiments, the method further comprises sending a vendor an electronic notification after directing an electronic purchase order to a vendor account.

In some embodiments, the method further comprises sending the customer an electronic notification after directing an electronic invoice to the customer account.

### BRIEF DESCRIPTION OF THE FIGURES

The present invention, in accordance with one or more various embodiments, is described in detail with reference to the following figures. The figures are provided for purposes of illustration only and merely depict typical or example embodiments of the invention. These figures are provided to facilitate the reader's understanding of the disclosure and shall not be considered limiting of the breadth, scope, or applicability of the disclosure.

FIG. 1 is a diagram illustrating the basic function of an electronic purchase order and invoice gateway according to one embodiment of the present invention.

FIG. 2 is a diagram illustrating an example of customer access of a General Accounts Payable report. In this example, a customer utilizes an electronic invoice gateway to manage transactions and access invoices from four vendors simultaneously.

FIG. 3 is a diagram illustrating an example of vendor access of a General Accounts Receivable report. In this example, a vendor utilizes an electronic invoice gateway to manage transactions and access outstanding invoices with three customers simultaneously.

FIG. 4 is a flow diagram illustrating an example of a computing module for implementing various embodiments of the disclosure.

These figures are not intended to be exhaustive or to limit the application to the precise form disclosed. It should be understood that embodiments of the application can be practiced with modification and alteration, and that the application be limited only by the claims and the equivalents thereof.

### DETAILED DESCRIPTION OF THE INVENTION

Various embodiments and aspects of the invention are described with reference to details discussed below, and the accompanying drawings illustrate some various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of some embodiments.

Reference in the specification to “one embodiment” or “an embodiment” indicates that a particular feature, structure, or characteristic described in conjunction with the embodiment can be included in at least one embodiment of the invention. The appearances of the phrase “in one embodiment” in various places in the specification does not necessarily all refer to the same embodiment.

An electronic invoice gateway is provided herein which provides electronic compilation and centralized customer access of outstanding invoices from multiple vendors. In some embodiments, the electronic invoice gateway additionally provides a centralized access point for the customer to submit electronic purchase orders to any of a variety of vendors.

In operation, vendors access the electronic invoice gateway to enter details of outstanding invoices keyed to individual customers. As these invoices are entered, and on an ongoing basis, an individual customer may access the electronic invoice gateway to retrieve their keyed invoices from all relevant vendors. The vendors can be, for example, the manufacturers, distributors, retailers, service brokers, purchasing houses, etc. of products, or service providers. Vendors may be the clients of the electronic invoice gateway of the present invention, or entities having a business relationship with the electronic invoice gateway. A vendor may access the electronic invoice gateway via any of a number of electronic communication channels or medias, such as, for example, Web, Web-enabled application, email, chat, voice (including automated interactive voice recognition or IVR, voice over Internet protocol or VoIP), video, and/or online community-based forum, etc.

Similarly, a customer may access the electronic invoice gateway via any of a number of electronic communication channels or medias, such as, for example, Web, Web-enabled application, email, chat, voice (including automated interactive voice recognition or IVR, voice over Internet protocol or VoIP), video, and/or online community-based forum, etc. According to some embodiments of the invention, a customer accesses the electronic invoice gateway via a Web-enabled application installed on a mobile device of a customer or user, such as a smart-phone, Web-enabled tablet, or laptop computer.

In some embodiments, a customer may also enter and submit purchase orders for any vendor registered with the electronic invoice gateway. In some related embodiments, the customer enters and submits purchase orders via a Web-enabled application installed on a mobile device of a customer or user. In these embodiments, the Web-enabled application provides a customer an interface for both purchase order submission and access to fulfilled orders (i.e., invoices).

Operation of the electronic invoice gateway in such embodiments may proceed as follows. A customer may access the gateway and submit an electronic purchase order for a particular vendor. The electronic purchase order is delivered to the vendor's account, and the vendor is sent notification of a new electronic purchase order. Notification is sent to the vendor, e.g., via email, text message, voice (including automated interactive voice recognition or IVR, voice over Internet protocol or VoIP), video, and/or online community-based forum, etc. The vendor then accesses the gateway to review and approve the purchase order.

If the vendor accepts the purchase order, the vendor enters a corresponding electronic invoice. The electronic invoice is delivered to the customer account, and the customer is notified that the invoice is available, e.g., via email, text message, voice (including automated interactive voice recognition or IVR, voice over Internet protocol or VoIP), video, and/or online community-based forum, etc. In some embodiments, a vendor's entry of an electronic invoice corresponding to a customer generated electronic purchase order is conducted automatically by the electronic invoice gateway. In these embodiments, a vendor's approval of an electronic purchase order comprises an option for automatic conversion of the electronic purchase order to an electronic invoice via a selection on the vendor's gateway interface. Upon a vendor's approval of an electronic purchase order, the electronic invoice gateway populates an electronic invoice based on the information in the approved electronic purchase order. The generated electronic invoice is then reviewed by the vendor, and upon approval, is delivered to the customer's account, as described above. In these embodiments, the entire process from submission of an electronic purchase order to delivery of an electronic invoice is conducted electronically through the gateway, with no uploading or downloading of external files.

In one embodiment, electronic invoice gateway has security log-ins for customers and vendors. In some embodiments, a security log-in allows a vendor or customer to access the electronic invoice gateway, and provides an identification key to a personalized interface. For example, a vendor may have the option of customizing invoice header fields, such as customer name, address, account number, contact information, shipping status, representative, payable date, anticipated deliver date, etc. Likewise, a customer may have the option of customizing purchase order header fields, such as vendor name, address, account number, contact information, etc.

In some embodiments, when an application is activated or launched by a customer or vendor, the application is configured to communicate with a service application programming interface (API) of the electronic invoice gateway. The electronic invoice gateway invokes a security system to authenticate the user based on the information transmitted from the application without requiring the user to specifically provide user information. For example, according to one embodiment, the customer may be authenticated based on a media access control (MAC) address or international mobile subscriber identity (IMSI) code of the mobile device associated with the customer. Such information may have been previously provided to the electronic invoice gateway when the customer registered with the electronic invoice gateway by installing an application, e.g., on the customer's Web-enabled mobile device.

In some embodiments, a vendor or delivery agent working on behalf of the vendor may access the gateway and note a successful or unsuccessful delivery attempt of an order. Thus, information regarding attempted deliveries may be available in real time to both vendors and customers. In some related embodiments, the vendor or delivery agent working on behalf of the vendor may access the gateway to enter delivery information via an application, e.g., installed on a Web-enabled mobile device.

Several other features may be included in certain embodiments. For example, the electronic invoice gateway may contain reporting features, such that the customer or vendor may access compiled purchase order and/or invoice information organized according to their search preferences. Specifically, in one embodiment, the customer may access a general accounts payable report, i.e., a single report containing information from all outstanding invoices from all vendors. Alternatively, in another embodiment, the customer may access outstanding invoices from a single, or multiple, vendors as selected by the customer. Or, in yet another embodiment, the customer may access all invoices and/or purchase orders, settled and outstanding, generated over a customer-defined time period.

Similarly, in some embodiments, vendors may access similar reports listing all accounts receivable, i.e., a single report containing outstanding invoices from all customers. Alternatively, in another embodiment, the vendor may access outstanding invoices issued to a single, or multiple, customers as selected by the vendor. Or, in yet another embodiment, the vendor may access invoices and/or purchase orders, settled and outstanding, generated over a vendor-defined time period.

Additionally, in some embodiments, historical account information may be available to vendors and/or customers to review previously submitted and fulfilled electronic purchase orders and/or invoices. For example, vendors and/or customers may be able to review previously submitted and fulfilled electronic purchase orders and/or invoices sorted by date range, involvement of one or more particular customers and/or vendors, or some combination thereof.

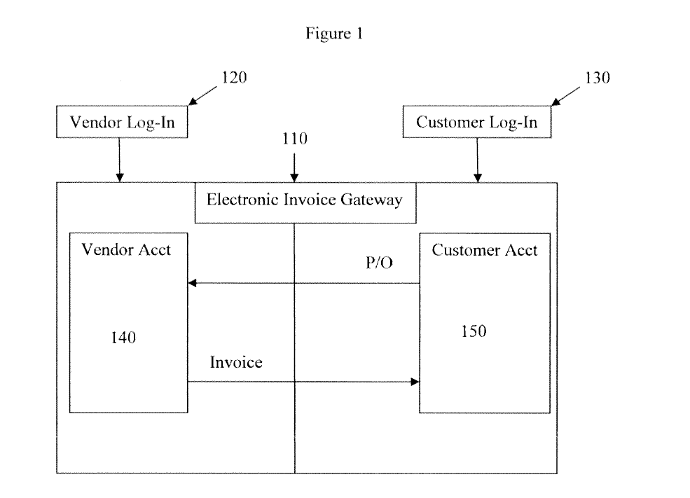

Referring to FIG. 1, a general overview of the basic function of an electronic purchase order and invoice gateway of one embodiment will now be described. Specifically, the electronic invoice gateway 110 allows for remote vendor log-ins 120 and customer log-ins 130. Once access is established, customers can electronically submit purchase orders to a specific vendor's account 140. The vendor then accesses, reviews and approves the electronic purchase order, all on the electronic invoice gateway 110. Once approved, the electronic invoice gateway 110 converts the purchase order into an invoice, which is reviewed and approved by the vendor for delivery to the customer's account 150.

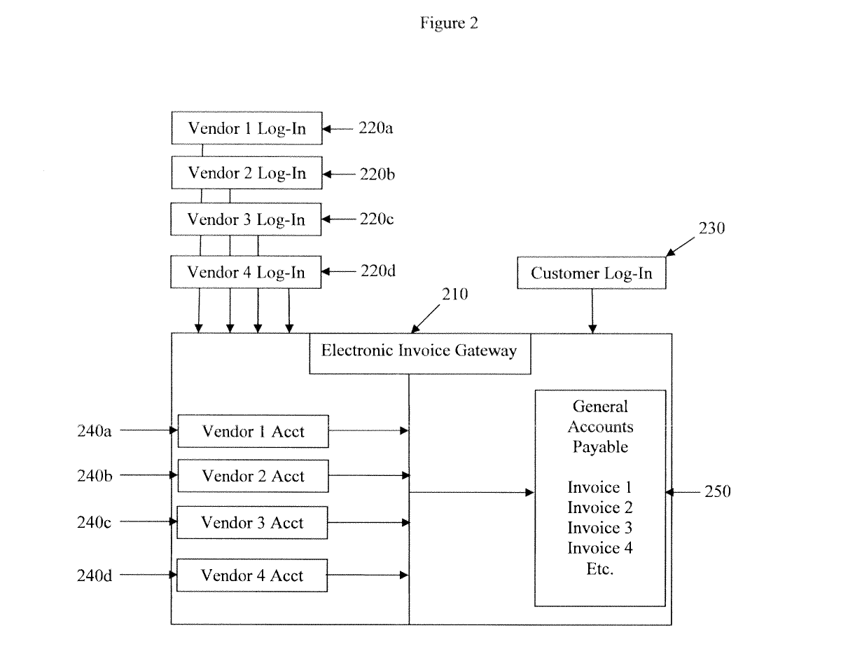

Referring to FIG. 2, an example of customer access of a General Accounts Payable report in one embodiment will now be described. In this example, a customer utilizes the electronic invoice gateway 210 to manage transactions from four vendors (shown in FIG. 2 as Vendor 1, Vendor 2, Vendor 3, and Vendor 4), wherein each vendor has its own respective log-in 220a-220d. The customer and all four vendors have separate accounts 240a-240d with the electronic invoice gateway 210. Through their account, the customer can compile outstanding invoices from all four vendors as a single General Accounts Payable report 250, thus simplifying tracking, and avoiding the time and expense of manual data entry, of invoices from multiple vendors.

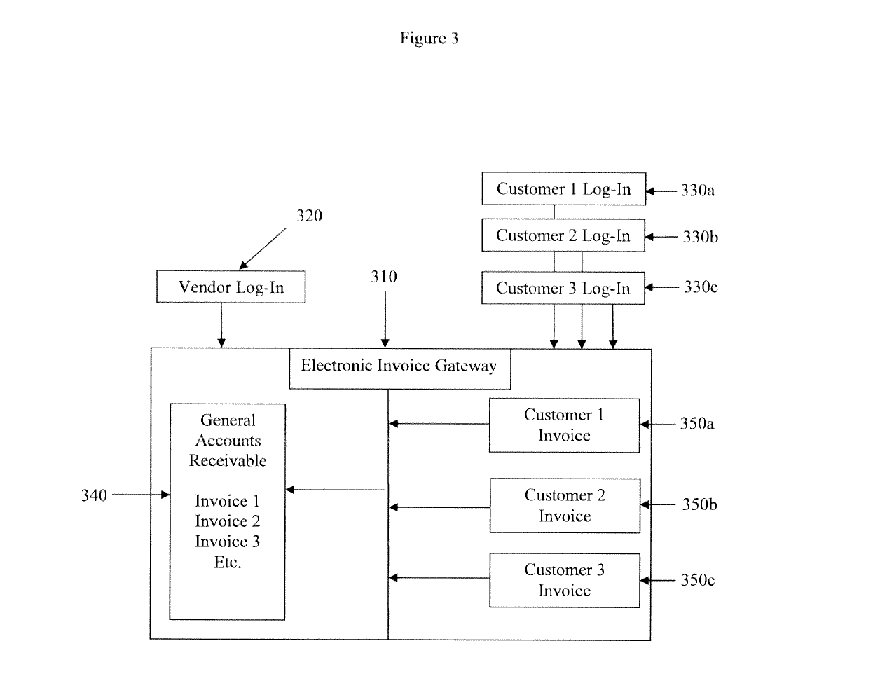

Referring to FIG. 3, an example of vendor access of a General Accounts Receivable report 340 in one embodiment will now be described. In this example, a vendor utilizes the electronic invoice gateway 310 to manage transactions with three customers (shown in FIG. 3 as Customer 1, Customer 2, and Customer 3). The vendor and all three customers have separate accounts with the electronic invoice gateway, wherein each party has its own respective log-in (i.e., Vendor log-in 320 and Customer log-ins 330a-330c). Through their account, the vendor can compile outstanding Customer invoices 350a-350c with all three customers as a single General Accounts Receivable report 340, thus simplifying tracking, and avoiding the time and expense of manual data entry, of invoices sent to multiple customers.

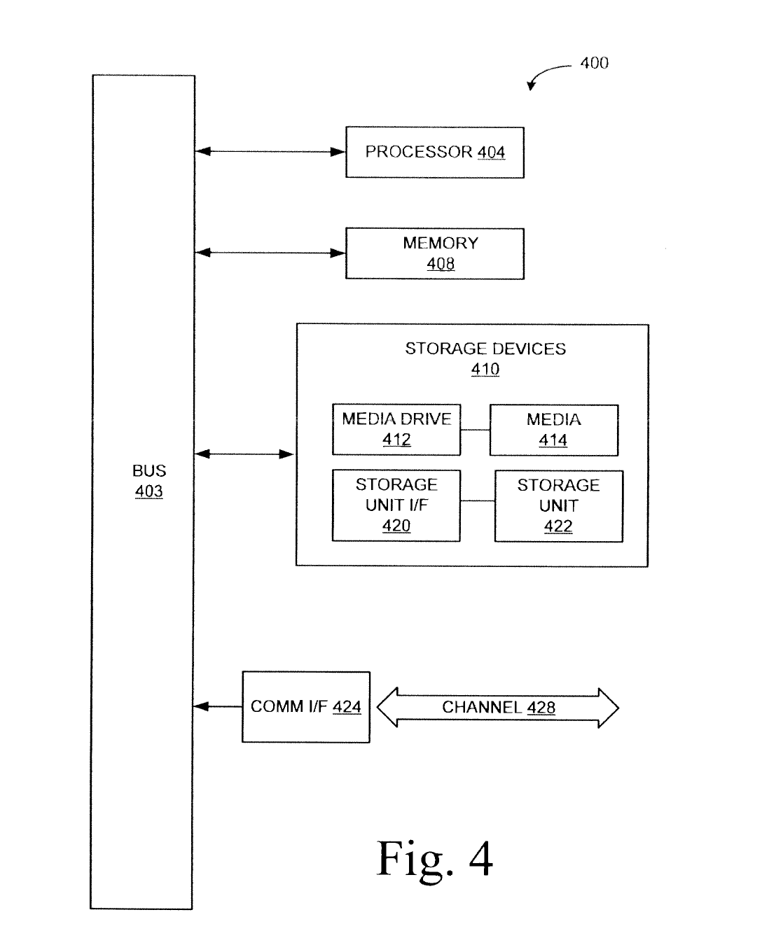

As used herein, the term “module” might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example of a computing module is shown in FIG. 4. Various embodiments are described in terms of this example-computing module 400. After reading this description, it will become apparent to a person skilled in the relevant art how to implement embodiments of the application using other computing modules or architectures.

Referring now to FIG. 4, computing module 400 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 403, although any communication medium can be used to facilitate interaction with other components of computing module 400 or to communicate externally.

Computing module 400 might also include one or more memory modules, simply referred to herein as main memory 408. For example, preferably random access memory (RAM) or other dynamic memory, might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 403 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a floppy disk drive, a magnetic tape drive, an optical disk drive, a CD, DVD or Blu-ray drive (R or RW), or other removable or fixed media drive might be provided. Accordingly, storage media 414 might include, for example, a hard disk, a floppy disk, magnetic tape, cartridge, optical disk, a CD, DVD or Blu-ray, or other fixed or removable medium that is read by, written to or accessed by media drive 412. As these examples illustrate, the storage media 414 can include a non-transitory computer readable medium having computer executable program code embodied thereon.

In alternative embodiments, information storage mechanism 410 might include other similar instrumentalities for allowing computer programs or other instructions or data to be loaded into computing module 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory module) and memory slot, a PCMCIA slot and card, and other fixed or removable storage units 422 and interfaces 420 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present application as discussed herein.

While various embodiments of the present application have been described above, it should be understood that they have been presented by way of example only, and not of limitation. Likewise, the various diagrams may depict an example architectural or other configuration for the disclosure, which is done to aid in understanding the features and functionality that can be included in the disclosure. The application is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present application. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the application is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer readable medium having computer executable program code embodied thereon, the computer executable program code configured to cause a computing device to provide a customer with simultaneous access to electronic invoices from one or more vendors by:
receiving electronic invoices from one or more vendors for transactions with a customer; and
directing said electronic invoices from the one or more vendors to a customer account associated with the customer;
wherein the customer can simultaneously access the electronic invoices from the one or more vendors by accessing their customer account.

2. The computer readable medium of claim 1, wherein the computer executable program code is further configured to cause a computing device to send an electronic notification to the customer when an electronic invoice is directed to the associated customer account.

3. The computer readable medium of claim 1, wherein the computer executable program code is further configured to receive electronic invoices from the one or more vendors via the internet.

4. The computer readable medium of claim 1, wherein the computer executable program code is further configured such that a customer accesses their account via the internet.

5. The computer readable medium of claim 1, wherein the computer executable program code is further configured such that a customer accesses their account via a web-enabled mobile device.

6. The computer readable medium of claim 1, wherein simultaneously access to the electronic invoices from the one or more vendors comprises access to a single report comprising electronic invoice data from said one or more vendors.

7. The computer readable medium of claim 1, wherein said one or more vendors is two or more vendors.

8. A non-transitory computer readable medium having computer executable program code embodied thereon, the computer executable program code configured to provide an electronic customer purchase order and vendor invoice gateway by:
receiving an electronic purchase order from a customer for a transaction with a vendor;
directing said electronic purchase order to a vendor account associated with the vendor;
receiving an electronic invoice from the vendor upon acceptance of the electronic purchase order; and
directing the electronic invoice to a customer account associated with the customer.

9. The computer readable medium of claim 8, wherein said computer executable program code is configured to receive a plurality of electronic purchase orders from a customer for transactions with a plurality of vendors.

10. The computer readable medium of claim 8, wherein the computer executable program code is further configured to cause a computing device to send an electronic notification to a vendor when an electronic purchase order is directed to the associated vendor account.

11. The computer readable medium of claim 8, wherein the computer executable program code is further configured to cause a computing device to send an electronic notification to the customer when an electronic invoice is directed to the associated customer account.

12. The computer readable medium of claim 8, wherein an electronic purchase orders is received from the customer via the internet.

13. The computer readable medium of claim 8, wherein an electronic purchase order is received from the customer via a web-enabled mobile device.

14. The computer readable medium of claim 8, wherein an electronic invoice is received from the vendor via the internet.

15. The computer readable medium of claim 1, wherein the computer executable program code is further configured such that a customer accessing their account may access electronic purchase orders previously sent to one or more vendors.

16. The computer readable medium of claim 1, wherein the computer executable program code is further configured such that a customer accessing their account may access electronic invoices previously sent by a vendor.

17. The computer readable medium of claim 1, wherein the computer executable program code is further configured such that a customer accessing their account may simultaneously access electronic invoices sent by a plurality of vendors.

18. The computer readable medium of claim 1, wherein the computer executable program code is further configured such that a vendor accessing their account may access electronic purchase orders previously sent by one or more customers.

19. The computer readable medium of claim 1, wherein the computer executable program code is further configured such that a vendor accessing their account may simultaneously access all outstanding invoices sent to a single customer.

20. The computer readable medium of claim 1, wherein the computer executable program code is further configured such that a vendor accessing their account may simultaneously access all outstanding invoices.

21. A method of processing electronic purchase orders and invoices from a single customer and a plurality of vendors, said method comprising:
receiving electronic purchase orders from a customer for a plurality of vendors;
directing each of said electronic purchase order to a vendor account associated with each vendor;
receiving an electronic invoice corresponding to each of said electronic purchase orders; and
directing the electronic invoices to a customer account associated with the customer.

22. The method of claim 21, the method further comprising sending a vendor an electronic notification after directing an electronic purchase order to a vendor account.

23. The method of claim 21, the method further comprising sending the customer an electronic notification after directing an electronic invoice to the customer account.
